(19) United States
(12) Patent Application Publication
(10) Pub. No.: US 2026/0367809 A1
(43) Pub. Date: Nov. 19, 2026

(54) HOST SYSTEM AND MEMORY REMOVABLY CONNECTABLE TO THE HOST SYSTEM TO FORM AT LEAST PART OF THE MEMORY SPACE OF THE HOST SYSTEM OR TO ELABORATE INSTRUCTIONS

(71) Applicant: ÉCOLE POLYTECHNIQUE FÉDÉRALE DE LAUSANNE (EPFL), Lausanne (CH)

(72) Inventors: Pasquale Davide SCHIAVONE, Geneve (CH); Clément CHONÉ, Renens (CH); Michele CAON, Collegno (IT); David ATIENZA ALONSO, Echandens-Denges (CH)

(21) Appl. No.: 19/207,352

(22) Filed: May 14, 2025

(51) Int. Cl. G06F 3/06

(52) U.S. Cl. CPC G06F 3/0625; G06F 3/0659; G06F 3/0673

(57) ABSTRACT

A system includes a host system having configuration registers and a system bus including at least one data bus to read and write data from at least one memory. The memory is removably connectable to the data bus forming at least part of the memory space of the host system, the memory including a pin routed to one of the configuration registers when the memory is connected to the host system. The memory is configurable by the host system in a transparent memory mode for reading and writing from/into the memory and a computing mode for programming elaboration kernels into the memory. The host system is configured to switch the memory between transparent memory mode and computing mode by setting one of the configuration registers in the host system. The host system, with the memory switched on the computing mode, is configured to program the elaboration kernels by transmission of instructions via the data bus and to read results directly therefrom, without loading and storing instructions.

### FIELD OF APPLICATION

The present invention relates to a system including
a host system comprising a system bus, including at least one data bus to read and write data from at least one memory instance (or core of several memory instances); and
at least one memory instance (or core of several memory instances) removably connectable to the data bus of the host system to form at least part of the memory space thereof,
   the system targeting different requirements at system and application level, such as complexity, performance, and integration with existing platforms, wherein the system is suitable for targeting on one side ultra-low-power and resource-constrained domains, such as but not limited to near-sensor AI-based signal processing on wearable devices (biomedical, audio, images or any other sensors/domain). Such applications rely on algorithms with a regular control flow, for example min/max search algorithms for peak detection and lightweight ANNs. On the other side, the system also targets highly-parallel applications across domains involving performance-critical and computationally-intensive workloads or tasks with a data-dependent control flow such as but not limited to AI-based image recognition and Natural Language Processing (NLP).

The present invention also relates to a memory suitable to be used in the systems of the type cited above.

### PRIOR ART

The last decades have witnessed a shift in the computing paradigm towards data-driven workloads, such as Artificial Neural Networks. These computationally expensive algorithms offer advanced functionalities in a wide range of applications by exploiting an exponentially increasing volume of data from the internet and Internet of Things (IoT) devices. In this context, edge computing has gained traction, driving the exploration of innovative computing architectures that provide superior energy efficiency and performance compared to traditional systems. These advances are crucial in overcoming the throughput, latency, and privacy limitations of centralized computing infrastructures while meeting the increased computational demands for real-time data processing in fields such as biosignals [D. Sussillo, P. Kaifosh, and T. Reardon, “A generic noninvasive neuromotor interface for human-computer interaction,” bioRxiv, 2024, audio [A. Raychowdhury, C. Tokunaga, W. Beltman, M. Deisher, J. W. Tschanz, and V. De, “A 2.3 nJ/frame voice activity detector-based audio front-end for context-aware system-on-chip applications in 32-nm CMOS,” IEEE Journal of Solid-State Circuits, vol. 48, no. 8, pp. 1963-1969, 2013], and video.

The accessible manufacture and deployment of low-power, high-performance, and software-friendly edge computing devices is a main requisite for supporting application of Artificial Intelligence (AI). The traditional von Neumann architecture, which has been the backbone of computing systems for decades, is inherently inefficient for data-intensive workloads due to the constant need to move data and instructions between the system memory hierarchy and the Central Processing Unit (CPU) registers (J. Backus, “Can programming be liberated from the von neumann style? A functional style and its algebra of programs,” Commun. ACM, vol. 21, no. 8, pp. 613-641, August 1978; M. Horowitz, “1.1 Computing's energy problem (and what we can do about it),” in 2014 IEEE International Solid-State Circuits Conference Digest of Technical Papers (ISSCC), February 2014, pp. 10-14, iSSN: 2376-8606).

This is exacerbated by Static Random-Access Memory (SRAM) integration technologies not keeping pace with logic scaling, an issue known as the memory wall (S. A. McKee, “Reflections on the memory wall,” in Proceedings of the 1st Conference on Computing Frontiers. Association for Computing Machinery, 2004, p. 162).

As a consequence, SRAM accesses typically account for 100× the energy of the arithmetic operations in the CPU, as noted by J. Hennessy and D. Patterson (J. L. Hennessy and D. A. Patterson, Computer Architecture: A Quantitative Approach. Morgan Kaufmann, November 2017, google-Books-ID: cM8mDwAAQBAJ).

The Compute-In-Memory (CIM) or Processing-In-Memory (PIM) paradigm has been proposed as a solution to this problem in the form of In-Memory Computing (IMC) and Near-Memory Computing (NMC) (S. Srinivasa, A. K. Ramanathan, J. Sundaram, D. Kurian, S. Gopal, N. Jain, A. Srinivasan, R. Iyer, V. Narayanan, and T. Karnik, “Trends and opportunities for SRAM based in-memory and near-memory computation,” in 2021 22nd International Symposium on Quality Electronic Design (ISQED), 2021, pp. 547-552; G. Singh, L. Chelini, S. Corda, A. J. Awan, S. Stuijk, R. Jordans, H. Corporaal, and A.-J. Boonstra, “Near-memory computing: Past, present, and future,” Microprocessors and Microsystems, vol. 71, p. 102868, 2019; O. Mutlu, S. Ghose, J. Gómez-Luna, and R. Ausavarungnirun, “Enabling practical processing in and near memory for data-intensive computing,” in Proceedings of the 56th Annual Design Automation Conference 2019, ser. DAC '19. New York, NY, USA: Association for Computing Machinery, 2019). Their common intuition is to move processing closer to the data to alleviate the instruction fetch overhead and the pressure on the system bus significantly while optimizing the utilization of the available memory bandwidth.

The preserved versatility of flexible memory access in near-memory systems suits the semantics of traditional programmable systems, where data processing is expressed through instructions operating on data from various memory locations. Consequently, the optimizations available in traditional von Neumann architectures, such as Single Instruction Multiple Data (SIMD) and vector operations, can be easily applied to Cl M systems. This was demonstrated in Y. Wang, M. Yang, C.-P. Lo, and J. P. Kulkarni, “30.6 Vecim: A 289.13 GOPS/W RISC-V vector co-processor with compute-in-memory vector register file for efficient high-performance computing,” in 2024 IEEE International Solid-State Circuits Conference (ISSCC), vol. 67, 2024, pp. 492-494, where energy efficiency of a vector coprocessor based on Ara (M. Cavalcante, F. Schuiki, F. Zaruba, M. Schaffner, and L. Benini, “Ara: A 1-GHz+ scalable and energy-efficient RISC-V vector processor with multiprecision floating-point support in 22-nm FD-SOI,” IEEE Transactions on Very Large Scale Integration (VLSI) Systems, vol. 28, no. 2, pp. 530-543, 2020) was further enhanced by integrating parts of the arithmetic circuitry within the Vector Register File (VRF) memory banks.

Controlling operations on NMC Integrated Circuits remains a challenge. The simplest control strategy involves streaming individual micro-operations to the NMC unit using an external CPU or Direct Memory Access (DMA) controller. This approach is very area-efficient, does not rely on a dedicated external controller, and scales well for regular packed-SIMD applications. However, complex runtime control requires either the CPU to spend significant time encoding such operations at runtime, decreasing system efficiency, or relying on predefined command sequences compiled offline, resulting in substantial code size overhead. In both cases, additional instructions and data must be fetched from the main memory before sending commands to the NMC ICs, reducing energy efficiency. Alternatively, custom controllers can assemble the necessary commands in hardware, increasing energy efficiency and throughput at the cost of reduced flexibility. To avoid micro-controlling the NMC unit, more complex and versatile controllers can be employed. For example, a dedicated CPU can be coupled with a NMC block to run small programs via a custom controller memory interface, avoiding standard load/store memory-mapped operations. This enables the execution of more complex programs independently from the host system, similar to a conventional accelerator, with the advantage of processing private data only, resulting in fewer data movements. However, such controllers trade flexibility for increased area and power, making them unsuitable for ultra-low-power, edge-oriented Systems-on-Chip.

To overcome the efficiency limitations of traditional von Neumann systems in handling data-centric workloads, recent research has explored alternative and more efficient computing paradigms. Among these, application- or domain-specific accelerators and CIM devices are the most prominent ones.

Concerning Energy-efficient Edge Accelerators the following has to be noted.

Fixed-function Application-Specific Integrated Circuits have been proposed for maximum performance and energy efficiency, whose predominant examples are ANN accelerators (F. Conti, D. Rossi, G. Paulin, A. Garofalo, A. Di Mauro, G. Rutishauer, G. m. Ottavi, M. Eggimann, H. Okuhara, V. Huard, O. Montfort, L. Jure, N. Exibard, P. Gouedo, M. Louvat, E. Botte, and L. Benini, “A 12.4TOPS/W @136GOPS AI-IoT system-on-chip with 16 RISC-V, 2-to-8b precision-scalable DNN acceleration and 30%-boost adaptive body biasing,” in IEEE ISSCC, 2023, pp. 21-23; C. Xin, Q. Chen, M. Tian, M. Ji, C. Zou, X. Wang, and B. Wang, “COSY: An energy-efficient hardware architecture for deep convolutional neural networks based on systolic array,” in 2017 IEEE 23rd International Conference on Parallel and Distributed Systems (ICPADS), 2017, pp. 180-189; C. Zhang, X. Wang, S. Yong, Y. Zhang, Q. Li, and C. Wang, “An energy-efficient convolutional neural network processor architecture based on a systolic array,” Applied Sciences, vol. 12, no. 24, p. 12633, 2022), specialized Digital Signal Processors for real-time data elaboration kernels such as Fast Fourier Transforms (M. Sinigaglia, L. Bertaccini, L. Valente, A. Garofalo, S. Benatti, L. Benini, F. Conti, and D. Rossi, “ECHOES: a 200 GOPS/W frequency domain SoC with FFT processor and I2S DSP for flexible data acquisition from microphone arrays,” in 2023 IEEE International Symposium on Circuits and Systems (ISCAS), 2023, pp. 1-5) or cryptographic coprocessors (A. Dolmeta, M. Mirigaldi, M. Martina, and G. Masera, “Implementation and integration of Keccak accelerator on RISC-V for CRYSTALS-Kyber,” in Proc. of the 20th ACM Int. Conf on Computing Frontiers, ser. CF '23, 2023, pp. 381-382). These ICs leverage highly parallel computing engines and optimized memory management units that maximize data reuse to achieve superior performance and energy efficiency, at the cost of reduced flexibility.

For scenarios requiring greater versatility, reconfigurable solutions such as embedded Field-Programmable Gate Arrays (P. D. Schiavone, D. Rossi, A. Di Mauro, F. K. Gürkaynak, T. Saxe, M. Wang, K. C. Yap, and L. Benini, “Arnold: An eFPGA-augmented RISC-V SoC for flexible and low-power IoT end nodes,” IEEE Transactions on Very Large Scale Integration (VLSI) Systems, vol. 29, no. 4, pp. 677-690, 2021) and Coarse-Grained Reconfigurable Architectures (R. R. Álvarez, B. Denkinger, J. Sapriza, J. M. Calero, G. Ansaloni, and D. Atienza, “An open-hardware coarse-grained reconfigurable array for edge computing,” in Proceedings of the 20th ACM International Conference on Computing Frontiers, ser. CF '23. New York, NY, USA: Association for Computing Machinery, 2023, pp. 391-392; and Z. Ebrahimi and A. Kumar, “BioCare: An energy-efficient CGRA for bio-signal processing at the edge,” in 2021 IEEE International Symposium on Circuits and Systems (ISCAS), 2021, pp. 1-5) can handle a wider range of workloads, although with a higher area and power overhead compared to ASICs. From a functional perspective, they often suffer from suboptimal resource utilization due to the complexity of the application mapping process, especially in on-line-reconfigurable CGRAs where spatial and temporal mapping constraints coexist. More conventional architectures preserve programmability while overcoming the instruction fetch overhead by offloading tasks to on-chip domain-specific processors (K. Li, W. Yin, and Q. Liu, “A portable DSP coprocessor design using RISC-V packed-SWID instructions,” in IEEE ISCAS, 2023, pp. 1-5), Vector Processing Unit (VPU) (M. Platzer and P. Puschner, “Vicuna: A timing-predictable RISC-V vector coprocessor for scalable parallel computation,” in 33rd Euromicro Conference on Real-Time Systems (ECRTS 2021), ser. Leibniz International Proceedings in Informatics (LIPIcs), B. B. Brandenburg, Ed., vol. 196. Dagstuhl, Germany: Schloss Dagstuhl—Leibniz-Zentrum für Informatik, 2021, pp. 1:1-1:18), or multi-core clusters with optimized data interconnects (A. Pullini, D. Rossi, I. Loi, G. Tagliavini, and L. Benini, “Mr. Wolf: An energy-precision scalable parallel ultra low power SoC for IoT edge processing,” IEEE Journal of Solid-State Circuits, vol. 54, no. 7, pp. 1970-1981, 2019).

These subsystems efficiently execute critical parts of the workload, reducing the pressure on the system bus and the memory hierarchy, thereby improving overall performance and energy efficiency. However, they still rely on a dedicated local memory that requires specific management in the application software, resulting in additional instructions and data movement. To address these limitations and leverage the benefits of domain-specific architectures while significantly reducing data movement, the flexibility and ease of implementation of programmable accelerators must be maintained while exploiting the advantages of the aforementioned CIM paradigm.

Concerning Compute Memories, instead, the following has to be noted.

I MC and NMC circuits enable concurrent data access from several memory banks and, in the case of IMC devices, also exploit the internal parallelism and structure of the memory arrays to enhance the arithmetic throughput with lower area overhead compared to conventional memory-mapped accelerators. Over the years, this concept has been applied at various levels of the memory hierarchy. Embedded Non-Volatile Memory (ENMV) technologies such as Magneto-resistive Random Access Memory (MRAM) (P. Deaville, B. Zhang, L.-Y. Chen, and N. Verma, “A maximally row-parallel MRAM in-memory-computing macro addressing readout circuit sensitivity and area,” in ESSCIRC 2021—IEEE47th European Solid State Circuits Conference (ESSCIRC), 2021, pp. 75-78), Phase-Change Memory (PCM) (L. He, X. Li, C. Xie, and Z. Song, “In-memory computing based on phase change memory for high energy efficiency,” Science China Information Sciences, vol. 66, 2023), and Resistive Random Access Memory (RRAM) (C.-X. Xue, W.-H. Chen, J.-S. Liu, J.-F. Li, W.-Y. Lin, W.-E. Lin, J.-H. Wang, W.-C. Wei, T.-Y. Huang, T.-W. Chang, T.-C. Chang, H.-Y. Kao, Y.-C. Chiu, C.-Y. Lee, Y.-C. King, C.-J. Lin, R.-S. Liu, C.-C. Hsieh, K.-T. Tang, and M.-F. Chang, “Embedded 1-Mb ReRAM-based computing-in-memory macro with multibit input and weight for CNN-based AI edge processors,” IEEE Journal of Solid-State Circuits, vol. 55, no. 1, pp. 203-215, 2020) have emerged as next-generation memory solutions enabling fast, power-efficient Multiply-and-Accumulate (MAC) operations in the analog domain, making them suitable for applications tolerating inexact results, such as ANNs. However, their stochastic nature also leads to reliability, uniformity, and portability issues, making them unsuitable for memory-critical applications (W. Banerjee, “Challenges and applications of emerging nonvolatile memory devices,” Electronics, vol. 9, no. 6, 2020). Consequently, research has also focused on DRAM- and SRAM-based solutions (C. Kozyrakis, S. Perissakis, D. Patterson, T. Anderson, K. Asanovic, N. Cardwell, R. Fromm, J. Golbus, B. Gribstad, K. Keeton, R. Thomas, N. Treuhaft, and K. Yelick, “Scalable processors in the billion-transistor era: IRAM,” Computer, pp. 75-78, 1997; M. Kooli, A. Heraud, H.-P. Charles, B. Giraud, R. Gauchi, M. Ezzadeen, K. Mambu, V. Egloff, and J.-P. Noel, “Towards a truly integrated vector processing unit for memory-bound applications based on a cost-competitive computational SRAM design solution,” J. Emerg. Technol. Comput. Syst., vol. 18, no. 2, April 2022.). Dynamic Random Access Memories (DRAMs) offer high density and large storage capacity, reducing data transfers from other memory devices, which is beneficial for data-intensive CIM scenarios. However, their high memory access energy limits their use in energy-constrained edge computing systems.

Conversely, Static Random-Access Memories (SRAMs) provide low-energy and faster memory accesses, motivating studies on SRAM-based IMC or NMC architectures (W. A. Simon, Y. M. Qureshi, M. Rios, A. Levisse, M. Zapater, and D. Atienza, “BLADE: An in-cache computing architecture for edge devices,” IEEE Transactions on Computers, vol. 69, no. 9, pp. 1349-1363, 2020). As a result, SRAM has become the predominant technology for data-intensive applications (A. A. Khan, J. P. C. D. Lima, H. Farzaneh, and J. Castrillon, “The landscape of compute-near-memory and compute-in-memory: A research and commercial overview,” 2024). In IMC devices, the integration of arithmetic circuitry within the memory array offers fine-grained optimization for superior performance and energy efficiency (S. Khoram, Y. Zha, J. Zhang, and J. Li, “Challenges and opportunities: From near-memory computing to in-memory computing,” in Proceedings of the 2017 ACM on International Symposium on Physical Design, ser. ISPD '17. New York, NY, USA: Association for Computing Machinery, 2017, p. 43-46.). However, this approach is highly invasive at the system level, introducing significant portability challenges and imposing strict data placement constraints that degrade application-level performance. In contrast, NMC architectures employ digital processing units placed outside the memory periphery. This choice leverages a standard digital integration flow, reducing implementation effort and enhancing portability across technology nodes. These advantages motivated the adoption of an NMC approach for the architectures disclosed. As alternative solutions, some studies have focused on developing hybrid IMC/NMC solutions (R. Gauchi, V. Egloff, M. Kooli, J.-P. Noel, B. Giraud, P. Vivet, S. Mitra, and H.-P. Charles, “Reconfigurable tiles of computing-in-memory SRAM architecture for scalable vectorization,” in Proceedings of the ACM/IEEE International Symposium on Low Power Electronics and Design, ser. ISLPED '20. New York, NY, USA: Association for Computing Machinery, 2020, pp. 121-126, and other already cited). From a technological standpoint, these hybrid approaches mitigate many challenges associated with fully IMC-based solutions. By placing most of the processing hardware outside the memory arrays, they maintain a clear separation between physical memory and arithmetic circuitry. This separation simplifies validation and verification while enabling faster architectural exploration. However, they still present integration challenges at the system level, which are addressed in this work. As discussed in A. A. Khan, J. P. C. D. Lima, H. Farzaneh, and J. Castrillon, “The landscape of compute-near-memory and compute-in-memory: A research and commercial overview,” 2024, strict data placement constraints, and the need for dedicated control schemes significantly hinder the development of a robust software deployment ecosystem. These factors, rather than technological limitations alone, remain a major barrier to the widespread adoption of CIM devices in real-world applications. In Y. Wang, M. Yang, C.-P. Lo, and J. P. Kulkarni, “30.6 Vecim: A 289.13GOPS/W RISC-V vector co-processor with compute-in-memory vector register file for efficient high-performance computing,” in 2024 IEEE International Solid-State Circuits Conference (ISSCC), vol. 67, 2024, pp. 492-494, Wang et al. propose Vecim, a RISC-V vector coprocessor leveraging a CIM-based VRF. Its modular design features configurable vector lanes that implement in-memory MAC operations through bit-line computing. This design achieves a state-of-the-art peak energy efficiency of 289.1 GOPS/W in 65 nm CMOS technology during an 8-bit matrix multiplication. Kooli et al. (already cited) present a Computational SRAM (C-SRAM) solution combining IMC and NMC to perform vector operations over memory rows. However, this approach suffers from low bitcell density due to data replication and the use of larger two-port memories. Gauchi et al. (already cited) propose a workload-aware, reconfigurable multi-tile C-SRAM architecture to enhance vectorization, albeit with higher area and power overhead, reduced versatility, and suboptimal utilization of the computing resources on small kernels. C-SRAM acts as a memory-mapped accelerator micro-controlled with commands encoded in bus write transactions.

The problem at the base of the present invention is that of providing a memory which is suitable to target different requirements at the system and application level, such as complexity, performance, energy efficiency, and integration within existing platforms. In particular:
Targeting simple data-driven workloads involving a regular control flow (e.g., AI-based signal processing of biomedical, audio, visual signals or other sensor domains) such as min/max search algorithms for peak detection (E. De Giovanni, F. Montagna, B. W. Denkinger, S. Machetti, M. Peón-Quirós, S. Benatti, D. Rossi, L. Benini, and D. Atienza, “Modular design and optimization of biomedical applications for ultralow power heterogeneous platforms,” IEEE Transactions on Computer-Aided Design of Integrated Circuits and Systems, vol. 39, no. 11, pp. 3821-3832, 2020), and lightweight ANNs (Z. He, X. Zhang, Y. Cao, Z. Liu, B. Zhang, and X. Wang, “LiteNet: Lightweight neural network for detecting arrhythmias at resource-constrained mobile devices,” Sensors, vol. 18, no. 4, p. 1229, 2018) used in arrhythmia detection
Targeting highly-parallel and complex edge computing applications (S. Soro, “TinyML for ubiquitous edge AI,” 2021) across domains involving performance-critical and computationally-intensive workloads (i.e., Deep Neural Networks (C. Gómez, P. Arbeláez, M. Navarrete, C. Alvarado-Rojas, M. Le Van Quyen, and M. Valderrama, “Automatic seizure detection based on imaged-EEG signals through fully convolutional networks,” Scientific reports, vol. 10, no. 1, p. 21833, 2020; U. R. Acharya, H. Fujita, O. S. Lih, Y. Hagiwara, J. H. Tan, and M. Adam, “Automated detection of arrhythmias using different intervals of tachycardia ECG segments with convolutional neural network,” Information sciences, vol. 405, pp. 81-90, 2017) or tasks with a data-dependent control flow.

### SUMMARY OF THE INVENTION

The technical problem mentioned above is solved by a system integrating the object of the present invention, including a host system and at least one memory. The expression “at least one memory” encompass “at least one memory instance” or “core of several memory instances”. The system includes
the host system comprising configuration registers and a system bus including at least one data bus to read and write data from at least one memory;
the at least one memory removably connectable to the data bus to form at least part of the memory space of the host system, the at least one memory including a pin routed to one of said configuration registers when the at least one memory is connected to the host system;
the at least one memory being configurable by the host system in one amongst a transparent memory mode for reading and writing from/into the at least one memory and a computing mode for programming elaboration kernels into the at least one memory;
wherein the host system is configured to switch the at least one memory between transparent memory mode and computing mode by setting said one of the configuration registers in the host system and
wherein the host system, with the at least one memory switched on the computing mode, is configured to program the elaboration kernels by transmission of instructions via the data bus and to read results directly therefrom, without loading and storing instructions.

An example of the system is schematically represented in a block diagram of FIG. 1. In this figure, reference number 1 indicates the host system, 2 the system bus, 3 the data bus, and 4 the at least one memory instance (or core of several memory instances).

Advantageously, this system supports two different types 4 of memory to address different applications requirements in terms of power, performance, and chip area. The first type of memory, referred to as NM-Caesar, supports simple workloads with a regular control flow, such as AI-based signal processing on biomedical, audio, image, or any other sensors data, or min/max search algorithms for peak detection and lightweight ANNs; the second type of memory, referred to as NM-Carus, supports highly-parallel workloads, possibly with a complex, data-dependent control flow usually suitable for the deployment on a CPU-based system. Possible applications domains include but are not limited to AI-based machine vision and Natural Language Processing (NLP) on text or audio data.

For the first type of memory, or NM-Caesar, an example of implementation is schematically represented in a block diagram of FIG. 2 and includes:
a controller 6 comprising with a decoder 7 connected to the routed pin “imc” used to change the memory operating mode (transparent memory mode or computing mode), and an arithmetic logic unit scheduler 8, wherein the decoder 6 is configured for interfacing with the data bus of the host system, and the arithmetic logic unit scheduler 8 is configured to schedule arithmetic operations according to the received instructions;
a data memory 9 which bitwidth is equivalent to the one of the host system data bus, wherein the data memory 9 includes a 2N (where N is integer) single-port SRAM banks 11
one or N arithmetic logic unit 10 is connected to the data memory 9 by means of a multiplexer connected to the 2N single-port SRAM banks, to the one or N arithmetic logic unit, and to the interface with the host system data bus.

The instructions, reported in Table I, include logic operations (AND, OR, XOR), addition and subtraction, multiplication, multiply-and-accumulate (MAC), dot product, minimum and maximum selection, and shift operations. Fixed and floating-point variants of the aforementioned arithmetic instructions are optionally supported by the device.

In the computing mode, the decoder is configured to interpret write transactions on the host system data bus as the instructions, wherein an opcode of the instructions is encoded in the most significant bits of the data bus. The opcode is followed by a word address of two source operands, relative to at least one memory base address.

NM-Caesar is an area-efficient, SIMD-enabled NMC unit micro-controlled by the host system.

Regarding the second type of memory, or NM-Carus, an example of implementation is schematically represented in a block diagram of FIG. 4 and includes:
a controller 61 including a Central Processing Unit (CPU) 62, an embedded memory 63, and a set of configuration registers 64 interconnected through a single-channel bus 65, the single-channel bus being connectable to said data bus of the host system by means of a multiplexer 66 also connectable to said one configuration register of the host system by means of said routed “ime” pin 5;
a Vector Processing Unit (VPU) 101 including an instruction decode stage 102 connected to the controller by a dedicated instruction offloading interface 200, an execution stage 103 to execute the instructions and a scoreboard unit (SCB) 104 tracking the execution progress of the in-flight instructions and handing synchronization with the CPU,
a data memory, the data memory forming a vector register file 110 including a configurable plurality of single-port SRAM banks 11.

The execution stage of the vector processing unit includes a configurable plurality of arithmetic logic units 10, a vector permutation unit 105, a loop unit 106 allowing iteration among the elements of a vector, and a CRS unit 107, and wherein each one of the single-port SRAM banks is connected to a corresponding one of the arithmetic logic units by means of a second multiplexer 67, the second multiplexer being connected to said multiplexer 66 via a data bus 300.

The configuration registers of the controller implement synchronization with the host system, exposing status information about the advancement of the kernel execution as well as parameters that control specific aspects of the leaded kernel such as the input data size.

The controller CPU is a RISC-V CPU implementing at least the RV32EC instruction set architecture (ISA).

The CPU is configured to offload instructions to the vector processing unit via a dedicated interface (for instance implemented with the OpenHW Group CORE-V X-IF, but it could be implemented with any other dedicated interface) 200.

The offloaded instructions are vector instructions from a custom “xvnmc” instruction set architecture extension, said custom xvnmc instruction set architecture extension implementing at least the following operations: integer single-width elementary arithmetic operations (addition, subtraction, multiplication, multiply-and-accumulate), logic operations (AND, OR, XOR), arithmetic and logic shift operations, maximum and minimum selection, vector permutation instructions comparable, and further implementing exchange of data between an element of a vector register and a scalar General-Purpose Register (GPR) in the controller CPU.

The exchange of data allows a CPU code to interact with a content of the vector register file, the vector register file being not accessible by the controller by any load and store instructions.

The custom “xvnmc” instruction set architecture extension includes instruction variants supporting indirect register addressing, wherein the variants encode index of source and destination vector registers in the three least-significant bytes of a scalar general-purpose register.

NM-Carus is a fully-autonomous, vector-inspired RISC-V-based programmable NMC unit.

Both NM-Carus and NM-Caesar are designed to be energy-efficient computing solutions as close as possible to a drop-in alternative to a traditional embedded SRAM bank both from a physical and functional standpoint. They offer an SRAM-compatible interface to the host system and have a functionally transparent memory operating mode alongside their computing mode. Their focus on programmability and ease of integration represents a significant advancement to address the challenges that prevent available CIM architectures from achieving broader adoption, as highlighted in (A. A. Khan, J. P. C. D. Lima, H. Farzaneh, and J. Castrillon, “The landscape of compute-near-memory and compute-in-memory: A research and commercial overview,” 2024).

In particular, the main contributions of the presented disclosure on emerging computing paradigms are:
A software-friendly, low-cost, and low-integration-effort approach to NMC in the context of general-purpose, low-power edge devices. Its effectiveness is demonstrated through the implementation of two architectural variations targeting various classes of embedded SoCs, NM-Caesar and NM-Carus.
Conception of a code-efficient RISC-V custom Instruction Set Architecture (ISA) extension “xvnmc” to support a flexible set of vector operations on programmable CIM architectures. The proposed extension provides a vector-based view of the host's compute memory without resulting in the overhead of explicit vector load/store operations.
An in-depth, quantitative, and vertical analysis of the impact and benefits of replacing conventional SRAM banks with the proposed NMC macros in low-power Microcontroller Units (MCUs).

Further characteristics of the system and memories according to the present invention are disclosed in the following description, given with reference to the enclosed drawings, only for exemplificative and non-limiting purpose.

### BRIEF DESCRIPTION OF THE ENCLOSED DRAWINGS AND TABLES

FIG. 1 is a block diagram of a system according to the present disclosure.

FIG. 2 is a block diagram of a memory of first type according to the present disclosure, also said NM-Caesar.

TABLE I is an instruction listing and accumulator operations of the NM-Caesar; all the instructions are element-wise unless otherwise specified. Instructions with the optional “_S” suffix are also provided in their optional fixed-point variant and those with the optional “_F” suffix are also provided in their optional floating-point variant.

FIG. 3 is an example timing diagram of NM-Caesar running two normal write operations (S0 and S1) and three arithmetic and logic instructions (mul, add, or).

FIG. 4 is a block diagram of a memory of second type, also said NM-Carus, according to the present disclosure.

TABLE II:“xvnmc” ISA extension instruction listing. Instruction variants in the second columns are expanded in Table III. Expressions between square brackets denote optional specifiers on top off the base instruction mnemonic, with alternative specifiers separated by a comma. Expressions between curly brackets denote different instructions with the same format and specifiers. Vector arithmetic operations are element-wise unless otherwise specified. Instruction with the [r] type can optionally use indirect register addressing. Instructions with the [s] or [f] opcode specifier are also provided in their optional fixed-point or floating-point variants.

Table III: NM-Carus instruction formats. The “xvnmc” extension is implemented inside the RISC-V Custom-2 25-bit encoding space with the 0x5b major opcode. The standard OPIVV, OPIVX, and OPIVI formats are used for the vv, vx, and vi instruction variants respectively, while ex and xe use the OPMVX format. Indirect register addressing is available for all vv, vx, and vi instructions.

FIG. 5 is an example timing diagram showing some custom vector instructions from “xvnmc” being offloaded from the controller CPU to the VPU in NM-Carus.

FIG. 6 schematically represents the internal organization of data inside the multi-bank NM-Carus data memory doubling as the Vector Register File for the integrated VPU.

Table IV reports the post-layout area and timing characteristics of a 32 KiB traditional SRAM, NM-Caesar, and NM-Carus when implemented on a low-power 65 nm CMOS technology node.

FIG. 7 shows the post-synthesis area breakdown of 32 KiB instances of NM-Caesar and NM-Carus in accurate scale.

FIG. 8 shows the physical layout of a 32 KiB (2×16 KiB) NM-Caesar instance.

FIG. 9 shows the physical layout of a 32 KiB NM-Carus instance, configured with a 4-lane vector register file based on four 8 KiB SRAM banks.

Table V: System-level throughput and energy improvement of the HEEPerator system, an edge-oriented MCU equipped with 32 KiB variants of the NM-Caesar and NM-Carus memories alongside traditional 32 KiB SRAM banks. The reported data was collected when executing the same computing kernels on NM-Caesar, NM-Carus, and on the system CPU. The data from the latter CPU-only implementation is used as a baseline for the relative analysis presented in the table. Throughput and energy improvements are computed as CPU data divided by NM-Caesar or NM-Carus data (higher is better). All software was compiled using GCC version 11.1.0 with the —O3 optimization option. Data source: post-layout simulation (65 nm, clock frequency: 250 MHz).

Table VI: Execution time and energy improvements and area overhead of NM-Caesar, NM-Carus, and two multi-core CPU-based systems (dual- and quad-core) with respect to a single-core CPU-based system when running the Anomaly Detection algorithm from the TinyML benchmark suite.

FIG. 10: Block diagram and code placement of the HEEPerator system used to evaluate NM-Caesar and NM-Carus performance.

FIG. 11A: Throughput gain of the NMC-enhanced HEEPerator MCU compared with its CPU-only version according to Table V.

FIG. 11B: Energy efficiency gain of the NMC-enhanced HEEPerator MCU compared with its CPU-only version according to Table V.

FIG. 12A: Matrix multiplication ([8, 8]×[8, P]) throughput scaling in 32 KiB NM-Caesar and NM-Carus instances with different input size.

FIG. 12B: Matrix multiplication ([8, 8]×[8, P]) energy scaling in 32 KiB NM-Caesar and NM-Carus with different input size.

FIG. 13: Average power breakdown in CPU, 32 KiB NM-Caesar, and 32 KiB NM-Carus for 8-bit and 32-bit 2D convolution.

Table VII: Comparison with existing state-of-the-art IMC and NMC solutions.

Table VIII: Peak performance comparison against existing state-of-the-art IMC and NMC solutions when executing a matrix multiplication kernel.

### DETAILED DESCRIPTION OF THE INVENTION

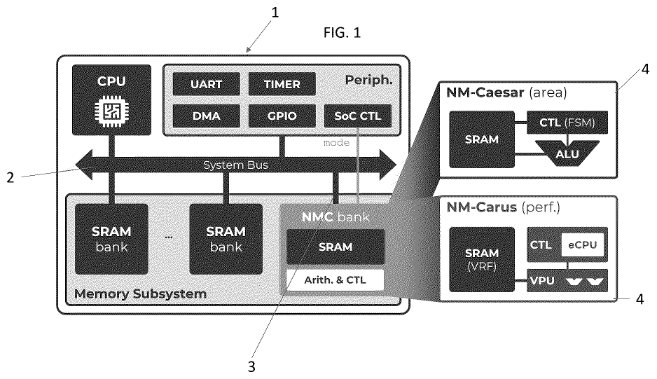

The system according to the present invention is based on a so called Near-Memory Computing paradigm. The main goal of the proposed NMC paradigm is to bring the efficiency of CIM to existing SoCs with minimal integration effort from a physical implementation and application deployment standpoints, providing an easy-to-deploy solution to the growing computational needs of next-generation edge computing devices. To achieve this result, the NMC device must adhere to two fundamental requirements:
1. functionally, it is part of the host system's memory space and should operate like a conventional memory during normal use;
2. from a physical implementation perspective, it represents a direct replacement for a standard SRAM memory bank, with similar area and timing characteristics. An overview of the resulting integration model is shown in FIG. 1.

The NMC device is also indicated in the present disclosure as a memory, or at least one memory to reflect the possibility to combine multiple NMC devices in the same multi-instance system (similar to what happens with multi-core systems in CPU-based devices) with increased performance and on-chip memory capacity compared to a single-instance variant. Accordingly, a system as disclosed includes a host system including at least one data bus to read and write data from the at least one memory; and at least one memory (the NMC device) removably connectable to the data bus to form at least part of the memory space of the host system. The at least one NMC device in such system relies on an arbitrary number of computing engines (i.e., arithmetic, logic, and permutation integrated circuits) and an arbitrary number of data memory bank connected to said computing engines.

For straightforward functional integration (1), the NMC device(s) connects to the system bus with a slave interface, similar to conventional memories. A transparent memory mode provides read and write access to the memory content, while a computing or configuration mode enables streaming or programming of arbitrary processing kernels. The data is processed in place within the IC private memory, which is managed and populated by the host CPU or DMA engine. The computation results are directly accessible by the host system, eliminating additional data movement towards the main system memory space, of which the NMC device(s) is part. All interactions take place on a memory-like interface, whose data write bus is used to encode and stream instructions when in computing mode. An additional imc pin, routed to a dedicated configuration register in the host system, switches the operating mode and is controlled by the software running on the host system CPU, without altering the bus protocol. Unlike other implementations in prior art where the address bus encodes instructions, this system according to the present disclosure avoids fragmentation of the address space and consequent mapping constraints when linking the firmware. The cost of setting and resetting the imc configuration register is negligible in common edge-computing workloads, where a long burst of operations is executed after preparing the input data to process and before using the results of the computation.

The physical integration (2) of the proposed NMC ICs is facilitated by the standard digital implementation flow for logic and the use of foundry-provided SRAM compilers for internal memories. This improves technological portability compared to IMC solutions that rely on custom memory arrays. The control and data processing units are carefully designed to maintain the timing characteristics of a reference conventional SRAM memory with the same capacity, while also minimizing the area overhead. Particular attention is paid to preserving the reference input and output delays, ensuring compatibility when replacing a standard memory bank with the NMC device.

FIG. 1 is a top-level block diagram of a NMC-enhanced MCU hosting, as part of its memory subsystem, a first type of memory according to the disclosure, also said NM-Caesar, which is suitable for area-critical implementations, or a second type of memory as disclosed, also said NM-Carus, suitable for performance-oriented applications.

Having established the system integration model and its implication in functional and physical aspects of the design, it is possible to motivate the design choices behind the NMC architectures. The fully digital NMC paradigm enables the development of configurable and scalable architectures, possibly covering diverse performance requirements. However, the physical constraints of the smallest class of IoT devices conflict with the level of flexibility that brings the most advantages to larger, performance-oriented systems. For these reasons, i.e. to address this trade-off, the two distinct NMC architectures for the two types of memories have been designed and implemented.

NM-Caesar targets low-cost SoCs with strict area and power constraints, such as near-sensor MCUs.

NM-Carus, on the other hand, fits well with those SoCs where a larger area budget can be allocated for increased performance and extended functionalities.

The different design goals are mainly reflected in the control strategy adopted in each device. NM-Caesar relies on the host system to stream SIMD instructions from a reduced ISA. In contrast, NM-Carus integrates a RISC-V-based controller supporting a custom CIM-oriented ISA, paired with a novel and scalable VPU for maximum flexibility through programmability and tunable parallelism at the data level. Since both architectures are designed for streamlined software deployment, their ISA and microarchitecture were tailored to support standard data types (8-, 16-, and 32-bit integers, and optionally fixed- and floating-point). Given the limited area budget, support for application-specific lower-precision data types was considered but not implemented, as many edge applications, such as health monitoring and audio processing, still rely on standard data types.

The two types of memories (and architectures) are disclosed in more detail hereafter, as two separate embodiments of the invention, examining their ISAs and microarchitecture.

### First Type of Memory: NM-Caesar

Minimizing the area overhead and power consumption of the NMC controller and arithmetic circuitry is the top-priority design criteria for the definition of NM-Caesar's ISA and microarchitecture, as explained below.

### NM-Caesar: Instruction Set Architecture

Designed for low-power edge computing applications, NM-Caesar ISA comprises operations that are common in Machine Learning (ML) algorithms such as Convolutional Neural Networks and support vector machines: arithmetic and logic operations that include multiplication, MAC, dot product, minimum and maximum selection, and shift operations to support integer and optionally fixed- and floating-point arithmetic. A summary of the supported instructions is shown in TABLE I.

When in computing mode, NM-Caesar interprets the write transactions on the bus as instructions. The opcode is encoded in the most significant bits of the data bus, followed by the word address of the two source operands, relative to NM-Caesar base address. On a 32-bit system, the opcode is encoded in the six most significant bits of the data bus, and the source operands offsets in two 13-bit fields in the remaining bits, for a total of 32 KiB of addressable space in a single NM-Caesar instance. Other encoding strategies are possible on systems with a different data parallelism. The address bus encodes the target address (destination address) as in normal memory accesses. For example, if a 32-bit NM-Caesar instance is mapped at base address BASE, the command to sum together the words at offset SRC1 and SRC2 and store the result at offset DEST can be assembled and issued online with the following C code:
*(BASE+DEST<<2)=ADD<<26|SRC2<<13|SRC1;

Alternatively to generating commands at runtime as shown above, an in-house domain-specific compiler can be used to assemble predefined sequences of NM-Caesar instructions that implement specific computational kernels. These are compiled and embedded into the host system formware and streamed to NM-Caesar by the host CPU or DMA controller during execution. As a third, more energy-efficient alternative, commands may also be issued by a dedicated hardware controller supporting a predefined set of kernels (as for example, but not limited to, matrix multiplications and convolutions), possibly with configurable data size and other parameters, without the need to fetch the command stream from the system memory. To efficiently deal with different data types, all NM-Caesar instructions are packed-SIMD. The data type is statically configured in a Control and Status Register (CSR) updated by a dedicated instruction to avoid repeated instruction encodings.

### NM-Caesar: Microarchitecture

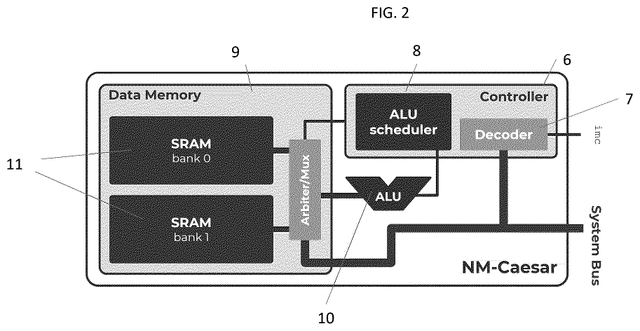

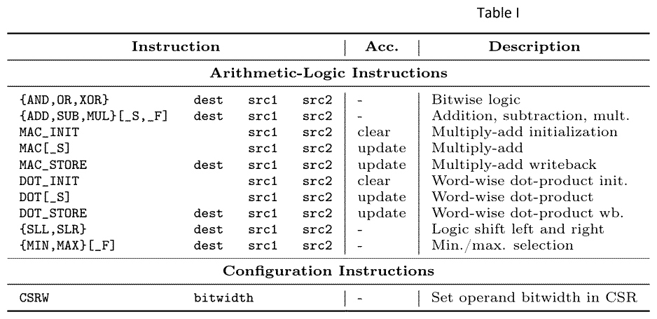

As shown in FIG. 2, an example 32 KiB implementation of NM-Caesar is composed of two single-port SRAM macros, an integer Arithmetic Logic Unit (ALU), and a controller that interfaces with the system bus, decodes incoming instructions, and schedules internal memory accesses and arithmetic operations. Internally, NM-Caesar can access both memory banks simultaneously to increase the bandwidth towards the ALU. Splitting the data memory into two smaller banks has a minor overhead in area and power due to the partially replicated periphery, yet it is more area-efficient than using a single dual-port memory for the same throughput. Other configurations for the internal memory and the amount of instantiated ALU are possible as long as the number of banks is double the number of ALUs, allowing the architecture to support different tradeoffs in terms of memory density and performance.

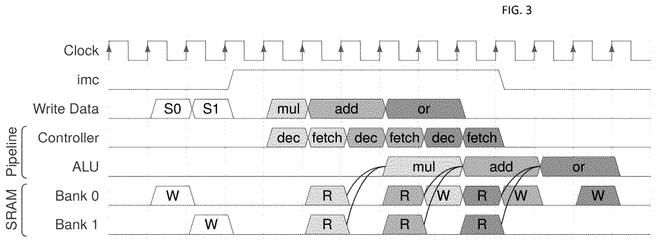

The received instructions go through four phases, handled by a 2-stage pipeline as shown in FIG. 3:
1. the instruction is decoded (controller dec stage), and the source and destination addresses are buffered;
2. in the next cycle, the source operands are fetched from the two memory banks (controller fetch stage);
3. the operands are received in the following cycle when the necessary ALU operation is scheduled. A new external request can be decoded at this point;
4. once the ALU provides the result, it is written back to the destination memory location.

To minimize the logic area and meet the same timing constraints of the reference SRAM, a multi-cycle, SIMD integer and optionally fixed- and floating-point ALU was selected. Choosing a single-cycle architecture would not improve performance as read and write contentions would occur at the memory ports. The ALU design is based on that of the CV32E40P core (M. Gautschi, P. D. Schiavone, A. Traber, I. Loi, A. Pullini, D. Rossi, E. Flamand, F. K. Gürkaynak, and L. Benini, “Near-threshold RISC-V core with DSP extensions for scalable iot endpoint devices,” IEEE Transactions on Very Large Scale Integration (VLSI) Systems, vol. 25, no. 10, pp. 2700-2713, 2017) ALU. NM-Caesar inherits its partitioned multi-precision adder supporting 8-, 16-, and 32-bit operations, here implemented with relaxed timing constraints to meet a 2-cycle propagation delay. The adder is used by the addition, subtraction, and minimum or maximum selection instructions. Unlike CV32E40P, which employs several parallel multipliers to perform single-cycle MAC and dot products, NM-Caesar employs four 17-bit multipliers and four adders producing one 8-bit, two 16-bit, and four 8-bit results every two cycles. Although no data placement constraints exist in NM-Caesar, the throughput is reduced to one operation every three cycles when both source operands come from the same memory bank, where they are accessed sequentially.

### Second Type of Memory: NM-Carus

NM-Carus architecture is designed to leverage the increased data-access efficiency brought by the NMC paradigm while also:
1. offering the advantages in terms of flexibility, scalability, and instruction fetch overhead that are typically offered by programmable vector machines and
2. relying on a scalable microarchitecture with configurable data-level parallelism.

To achieve (1) and (2), NM-Carus integrates an innovative controller based on a small RISC-V CPU, placed near the internal SRAM banks and called embedded CPU (eCPU) to distinguish it from the external host system's processor. A small memory, the embedded Memory (eMEM), is programmed by the host system with the CIM kernel to execute and provides minimal support for stack and heap. The eCPU offloads vector instructions from the custom xvnmc ISA extension to a novel, area-efficient, scalable VPU. Unlike NM-Caesar, NM-Carus controller is Turing-complete and fully programmable using any RISC-V-compatible software build toolchain. Support for the xvnmc instruction set is currently provided at the assembler level in the GNU Compiler Collection (GCC). For the first time, a memory (NM-Carus) according to the present invention is a software-programmable, autonomous embedded memory device that supports vector operations through a new NMC-specific RISC-V ISA extension (xvnmc).

Despite integrating a CPU, NM-Carus remains a memory from a system perspective, following the same system integration model of NM-Caesar. The absence of integrated load-store units and master ports in its external interface is what differentiates NM-Carus from a traditional memory-mapped accelerator. On the other hand, the main difference between NM-Carus and an isolated vector coprocessor with a private memory is the emphasis on the memory capacity over processing resources. The VRF, which contributes to at least half of NM-Carus die area, is memory-mapped from a system perspective, and it is the only data source for the internal VPU. In contrast, traditional vector units load and store data from external memories, offering greater flexibility in VRF data layout but at the cost of increased and more expensive data movements.

### NM-Carus: Instruction Set Architecture

The xvnmc RISC-V custom vector extension is specifically designed for small and efficient NMC devices to provide sufficient support for parallel workloads while limiting the hardware implementation cost. The extension is heavily inspired by the standard RISC-V Vector Extension (RVV) (RISC-V Corp., RISC-V ‘V’ Vector Extension, version 1.0, 2022. [Online]. Available: https://github.com/riscv/riscv-v-spec) and mostly shares the same instruction formats and semantics. RVV's built-in support for stripmining and very large vectors (up to 64 KiB vectors) perfectly aligns with NM-Carus scalable and memory-centric microarchitecture, allowing the same code to run on implementations with diverse VRF sizes.

The xvnmc custom instructions according to an embodiment as disclosed are listed in TABLE II. Instruction variants are expanded in TABLE III. Vector arithmetic operations are element-wise unless otherwise specified. Instruction with the [r] type can optionally use indirect register addressing. Addition, subtraction, multiplication, and multiply-and-accumulate instructions are also optionally provided in a fixed- and floating-point variant, denoted by the [s] or [f] optional opcode specifier in TABLE II. In TABLE III, NM-Carus instruction formats is disclosed. The xvnmc extension is implemented inside the RISC-V Custom-2 25-bit encoding space with the 0x5b major opcode. The standard OPIVV, OPIVX, and OPIVI formats are used for the vv, vx, and vi instruction variants respectively, while ex and xe use the OPMVX format. Indirect register addressing is available for all vv, vx, and vi instructions.

The xvnmc custom instructions implement integer and optionally fixed- and floating-point arithmetic, logic, and shift operations as well as vector permutation instructions comparable to the standard RVV counterparts. Besides, xvnmc adds two instructions, xvnmc.emvv and xvnmc.emvx|, dedicated to exchanging data between an arbitrary element of a vector register and an arbitrary scalar General-Purpose Register (GPR) in the eCPU. This is the only mechanism supported for the eCPU code to interact with the VRF content, which is not accessible through normal load and store instructions. Consequently, the eCPU instructions and private data are stored in the eMEM instead. Vector load and store instructions are not necessary: NM-Carus VPU works directly in the host system memory space, relying on the system to populate its VRF.

One significant issue when combining a vector ISA without vector loads and stores with the proposed CIM model is that the layout of the data in the VRF is not chosen by the vector kernel. As a consequence, N vector instructions with different source and destination registers would be needed to iterate over N chunks, or rows, of the input data mapped to N vector registers. With standard vector instructions, this would translate into a full unrolling of the iteration process. Nested loops in the kernel exacerbate the problem, making the code size grow exponentially. This is not an issue in a traditional vector machine, which can conveniently load data from any memory location into the same vector registers in every loop iteration. In contrast, the data layout in NM-Carus VRF is dictated by the host system and thus potentially unknown at compile time if the memory is allocated dynamically. It would not be possible to use the same kernel for different register subsets if the source and destination registers were hardcoded as immediate values in the kernel's vector instructions as in the standard RVV. Moreover, the eMEM offers very limited space for the kernel code, whose size is, therefore, a major concern.

To address both of these issues, the xvnmc extension provides instruction variants supporting indirect register addressing. These variants encode the index of the source and destination vector registers in the three least-significant bytes of a scalar GPR (rs2). This solution supports up to 256 logical vectors, accommodating applications with diverse data shapes (similar to R. Gauchi, V. Egloff, M. Kooli, J.-P. Noel, B. Giraud, P. Vivet, S. Mitra, and H.-P. Charles, “Reconfigurable tiles of computing-in-memory SRAM architecture for scalable vectorization,” in Proceedings of the ACM/IEEE International Symposium on Low Power Electronics and Design, ser. ISLPED '20. New York, NY, USA: Association for Computing Machinery, 2020, pp. 121-126). As a result, the same vector instruction can be reused in every loop iteration with different operands by simply updating the GPR containing their indexes. Consequently, the code size is drastically reduced, and the same kernel can be used for input data with different base addresses and iteration counts (i.e., input data size). This mechanism is equivalent to updating the base address for a load or store instruction in a conventional software loop and, therefore, could easily be integrated into a custom compiler. Moreover, because a single GPR encodes all the instruction operands, updating their indexes only requires a single \mintinlinegas|add| instruction, further reducing the code size. The execution time of index-updating instructions is normally hidden by the latency of the last issued vector instruction, due to NM-Carus ability to execute scalar and vector instructions in parallel. The energy cost of index management instructions is negligible compared to vector operations, as shown by the low contribution of the eCPU to the total energy in FIG. 12. Finally, the absence of vector load and stores makes the xvnmc ISA completely independent of the data bitwidth, further increasing reusability compared to RVV.

The newly proposed xvnmc ISA, therefore, offers a software-friendly, architecture-agnostic interface to leverage the proposed CIM model, bridging the host system's memory view of the CIM device with a convenient internal register view. Through vector processing, data-level parallelism and energy efficiency are increased, while a smaller code size and increased reusability compared to conventional vector ISAs are achieved using indirect vector register addressing. From an application standpoint, the interaction between the host CPU and the NM-Carus instance is implemented through a driver that allows developers to program the eMEM inside the controller with a xvnmc program selected from a library of precompiled kernels. Although support for the xvnmc extension is currently available only at the assembler level, its compatibility with the standard RISC-V ISA and its similarity to the standard RVV facilitate potential integration at the compiler level for automatic kernel generation starting from high-level languages.

### NM-Carus: Microarchitecture

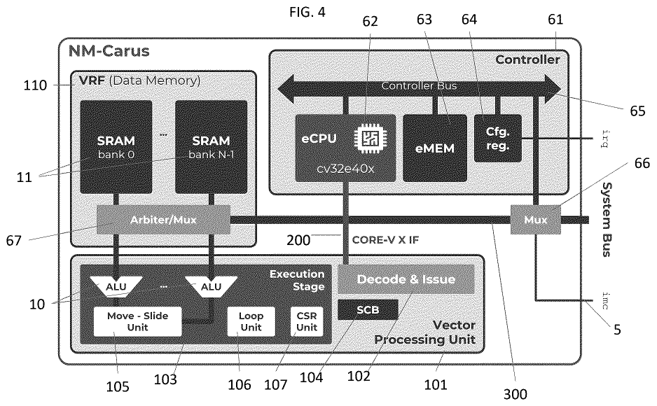

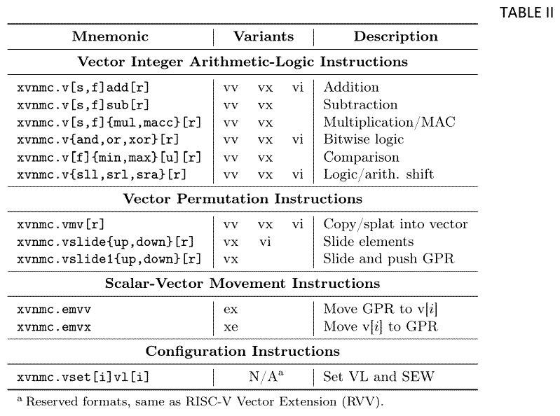

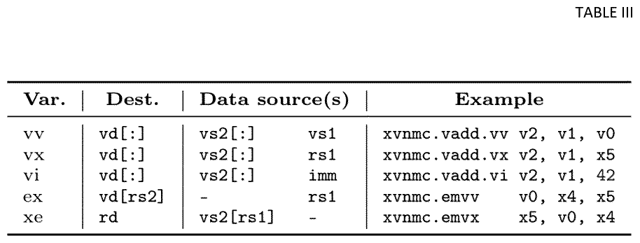

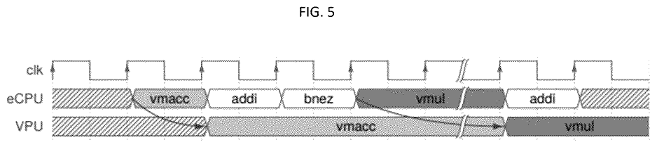

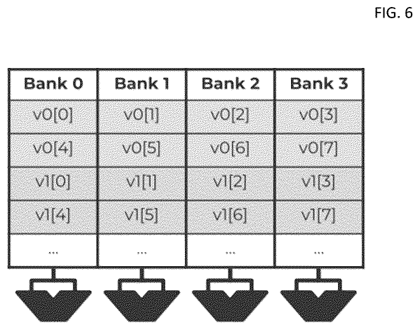

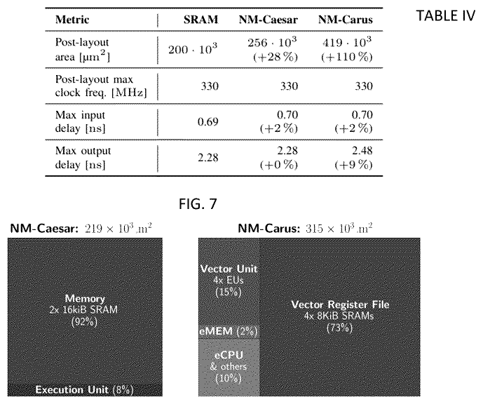

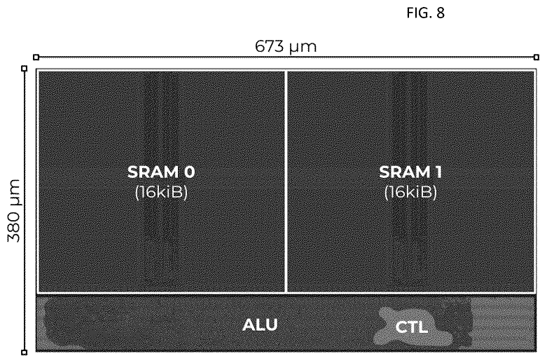

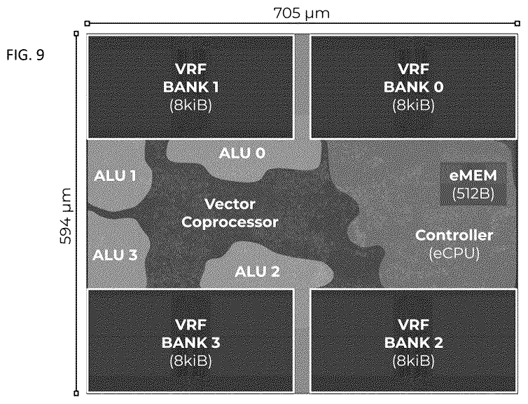

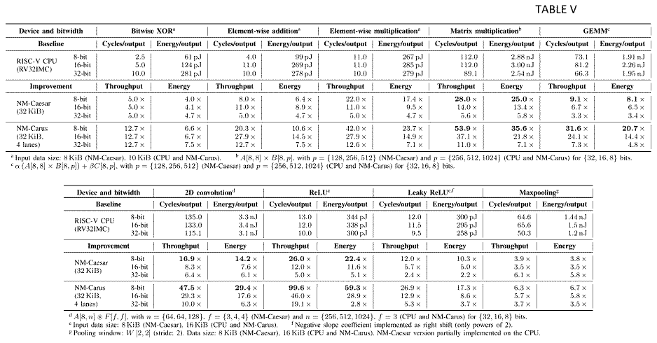

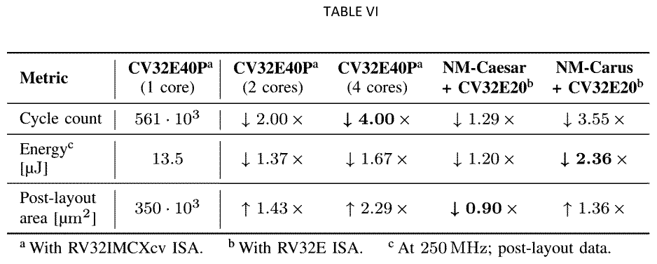

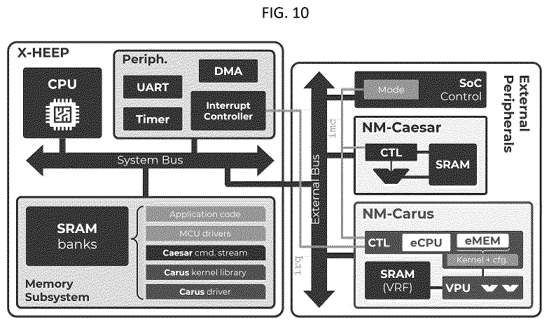

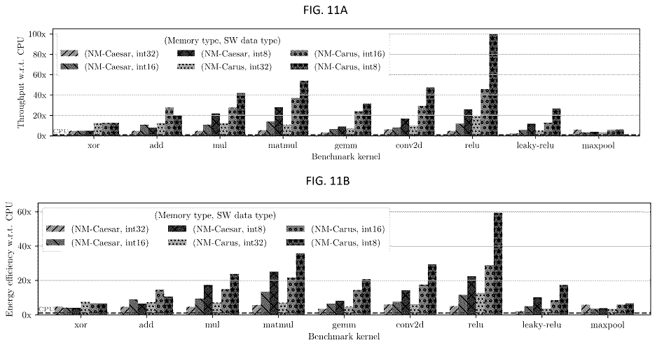

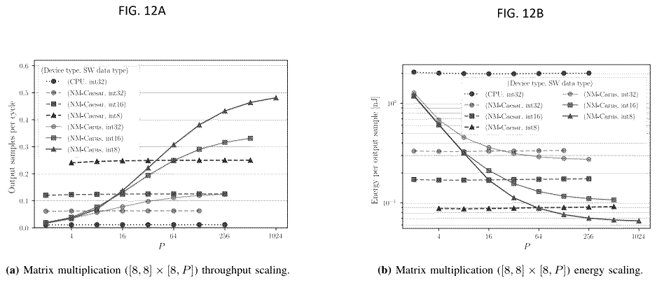

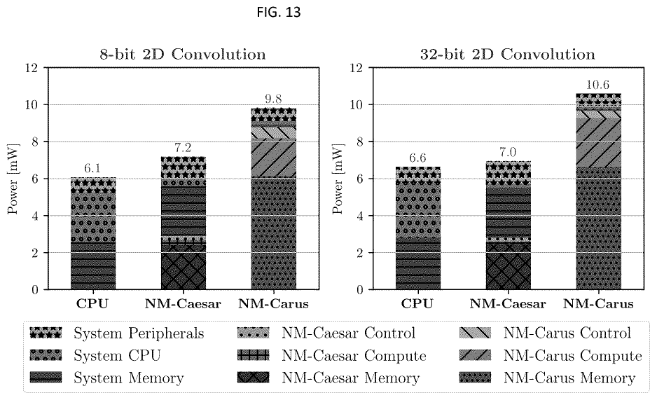

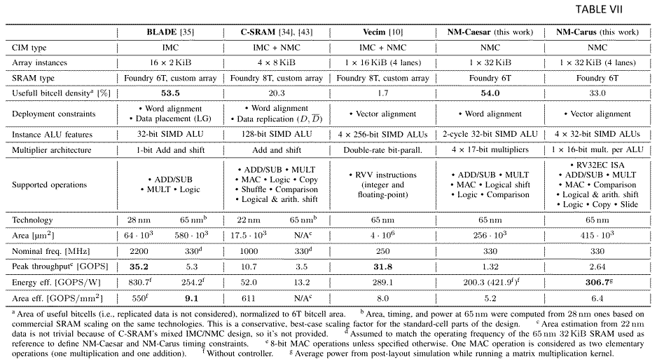

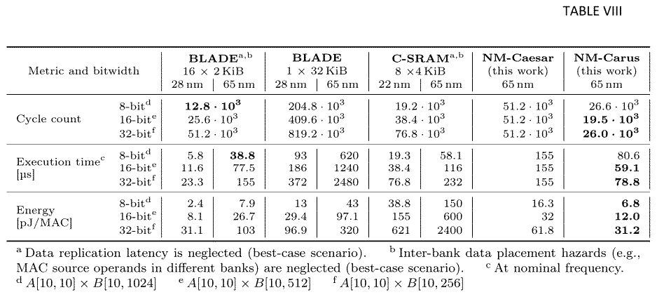

An example block diagram of NM-Carus microarchitecture is presented in FIG. 4.

NM-Carus controller is essentially a minimal SoC featuring the CPU (in the example the OpenHW Group 4-stage, in-order CV32E40X (OpenHW Group, “OpenHW Group CV32E40X user manual,” online, 2023, accessed: today. [Online]. Available: https://docs.openhwgroup.org/projects/cv32e40×-user-manual/en/latest/index.html) RISC-V core) 1 (eCPU), a tiny code memory (eMEM), and a configuration register that implements the synchronization interface with the host system. To minimize the core area, the eCPU can implement the RV32EC ISA, offering 16 GPRs and no hardware multiplication and division. Instructions from the xvnmc extension are offloaded by the eCPU to the VPU through a dedicated interface. In the example, the CORE-V X-IF interface was used (“OpenHW Group specification: Core-V eXtension interface (CV-X-IF),” online, 2023, accessed: today. [Online]). Available: https://docs.openhwgroup.org/projects/openhw-group-core-v-xif/en/latest/index.html)). All controller components are interconnected through a single-channel bus that is exposed to the host as a memory-mapped slave peripheral through the multiplexed memory-like interface that is also used to access NM-Carus data memory. In configuration mode, the host can program the eMEM with the kernel code or trigger and check the kernel execution by accessing the configuration register. NM-Carus can be set back to normal memory mode during the kernel execution so that normal memory operations are possible (e.g., to implement double buffering). Once the kernel terminates, a dedicated status bit is set to signal the end of the computation to the host system. As an alternative to software polling, this bit is routed to a dedicated optional pin in the NM-Carus top-level interface, which may be used as an interrupt source to allow the host system to enter a low-power state during computation. xvnmc.emvx instructions are the only ones that cause data hazards between vector and scalar instructions. Therefore, in most cases, scalar and vector instructions can be executed in parallel as shown in FIG. 5, reducing the kernel execution time.

NM-Carus VPU is implemented as a single-issue vector machine with a configurable level of hardware unrolling. The pipeline is composed of three main parts:
1. a decode stage interfacing with the eCPU and issuing decoded controls and scalar data to the execution units,
2. an execution stage with three dedicated units handling arithmetic, permutation, and CSR instructions, and
3. a shared commit unit keeping track of the execution status of the two in-flight instructions through a minimal scoreboard and handling synchronization with the eCPU.

The entire VPU is in low-power mode (e.g. clock-gated) when no vector instructions are in flight. The rationale behind a single-issue design is to keep the control and arbitration logic and internal buffers as small as possible. Consequently, most of the available area and power budget is allocated to the arithmetic circuitry, which ultimately determines the throughput of the VPU. A wider or deeper execution pipeline typical of performance-oriented vector machines [M. Cavalcante, F. Schuiki, F. Zaruba, M. Schaffner, and L. Benini, “Ara: A 1-GHz+ scalable and energy-efficient RISC-V vector processor with multiprecision floating-point support in 22-nm FD-SOI,” IEEE Transactions on Very Large Scale Integration (VLSI) Systems, vol. 28, no. 2, pp. 530-543, 2020] would have guaranteed a greater utilization of the functional units and VRF data interfaces. However, because NM-Carus is intended to be configured with a large VRF, the idle time of the execution units is negligible compared to the total execution time of each instruction, which fails to justify the additional hardware and power cost required to minimize it. NM-Carus data memory is implemented as a configurable number of single-port, SRAM banks with arbitrary capacity. The VRF architecture supports a minimum of 32 and a maximum of 256 logical vector registers. The chosen data interleaving policy, shown in FIG. 6 for an example configuration with four SRAM banks, maps memory words that are contiguous inside the host system address space to adjacent VRF banks. All vector registers are aligned with the physical banks, so elements with the same index from different vectors are physically mapped to the same VRF bank. This enables straightforward vector unrolling, with all the operands of an element-wise instruction being mapped to the same bank. Therefore, each ALU in the arithmetic unit is connected to a single SRAM bank, forming an independent computing lane. Consequently, NM-Carus VPU can be scaled arbitrarily: a higher number of lanes increases the unrolling level, thus improving throughput at the cost of increased area and power consumption. Because all operands come from the same bank, they must be accessed sequentially. This does not represent a bottleneck since NM-Carus relies on small serial arithmetic circuits, offering compelling advantages from an implementation point of view compared to parallel implementations. Providing the necessary throughput to parallel arithmetic units would also require larger and less efficient multi-port memory banks or more complex VRF layouts with additional routing and hazard-detection hardware. In addition, the supported vector instructions range from a minimum of one vector source operand (e.g., xvnmc.vadd.vx) per result to a maximum of three (e.g., xvnmc.vmacc.vv). Optimizing the memory access patterns for such a wide range of operations would exacerbate the issue.

At the core of NM-Carus VPU is an execution engine with three dedicated execution units: (2.a) an arithmetic unit handling integer and optionally fixed- and floating-point arithmetic and logic instructions, (2.b) a move-slide unit performing permutation and scalar-vector movement operations, and (2.c) a CSR unit managing the access to the vtype CSR encoding the current vector length and element bitwidth. A shared loop unit generates the VRF addresses to iterate among the elements of the source and destination vectors. The datapaths of (2.a) and (2.b) are interdependent since the ALUs inside the arithmetic unit and their internal registers are exploited to buffer intermediate data from both arithmetic and permutation operations. Similarly, resource sharing is heavily exploited inside the ALUs to implement packed-SIMD operations with minimal area. To this purpose, each ALU is equipped with a partitioned multi-precision adder (similar to NM-Caesar's one), a multiplier, elementary logic operators, and a logic and arithmetic barrel shifter. Every ALU performs the same operation on different elements of the same vector. Therefore, all lanes share the same ALU control unit and memory access scheduler. The compute and memory access patterns ensure that the throughput of the arithmetic unit is never lower than the slower unit between the ALU and the VRF for any combination of ALU operation and operand bitwidth. Most notably, assuming a 32-bit implementation with an ALU based on a single partitioned 16-bit adder/subtractor and a single 16-bit multiplier, an iteration of the xvnmc.vmacc.vx instruction at the core of many linear algebra operations is executed in each lane with a throughput of 1 MAC/cycle, 0.67 MAC/cycle, and 0.33 MAC/cycle for 8-bit, 16-bit, and 32-bit operands, respectively.

Here after, the physical implementation of both the types of memories according to an embodiment of the disclosure is given.

NM-Caesar and NM-Carus have been implemented in a 32 KiB configuration on a low-power 65 nm CMOS technology library. The automated digital flow relies on EDA tools for logic synthesis and place and route. To meet the design goal of implementing two drop-in replacements for standard SRAM memories, the cycle time and input/output delay constraints under worst-case conditions were set to match those of a single-port reference 32 KiB memory macro generated by the same SRAM compiler used for internal SRAM banks. The same metal stack of standard SRAM macros was used, which favours little to no effort when integrating the NMC macros in a host system. The post-layout area and timing characteristics of the NMC macros are summarized in Table IV, while the post-synthesis area breakdown is shown in FIG. 7. The 32 KiB configuration discussed in this section is used as a reference implementation used to assess the figures of merit of the proposed architecture, and shall not be considered the only configuration covered by the disclosed invention. The following sections discuss the implementation details of each NMC IC.

TABLE IV disclose the post-layout area and timing characteristics of 32 KiB implementations of NM-Caesar and NM-Carus, compared with a 32 KiB traditional SRAM bank, all implemented on a low-power 65 nm CMOS technology node.

### NM-Caesar

In a 2×16 KiB configuration for its internal memories, NM-Caesar meets the target 330 MHz clock frequency of the reference 32 KiB SRAM bank. The output delay is unchanged, while the worst-case input delay is 2% higher. The post-layout area 673×380 μm², corresponding to an overhead of 28% over the reference 32 KiB SRAM. FIG. 8 shows the floorplan of NM-Caesar, highlighting its main internal components. The two memory banks are placed on the top of the design to minimize the distance between the logic and the interface pins in the lower part of the IC. This ensures the same pin orientation of the reference SRAM bank, easing the system-level routing phase while relaxing the timing constraints.

### NM-Carus

NM-Carus has been implemented in a four-lane configuration, with the controller and VPU placed in the middle of four 8 KiB SRAM macros constituting the internal VRF as shown in FIG. 9. The eMEM (embedded memory) is implemented as a 512 B register file macro. The target 330 MHz clock frequency is met while the input and output delays are increased by 2% and 9% respectively due to the additional multiplexing logic that connects either the correct VRF bank or the controller bus to the shared external bus interface. The post-layout area is 705.0×594.4 μm², approximately corresponding to twice the area of the reference 32 KiB SRAM, therefore meeting the target 50% memory to logic ratio. Although most of the increased area overhead compared to NM-Caesar comes from NM-Carus additional logic, it is partially determined by the sublinear scaling of the footprint of an SRAM with its reduction in size. As visible in FIG. 7, NM-Carus 4-bank data memory is larger than NM-Caesar's 2-bank one, despite their identical capacity.

Placing the VRF banks at the corner of the NM-Carus floorplan partially counteracts the routing congestion, which is the main reason behind the low 60% logic density. With this solution, the VPU vector permutation unit, which interconnects all the VRF banks, is placed in the center of the IC, minimizing the wire length. Extra space is left between adjacent memories to route the NM-Carus input and output pins to the middle logic part, limiting timing penalties while keeping the pins on the bottom side as in the reference macro. Implementations based on more advanced technology nodes would benefit from the higher scaling of logic compared to the SRAM arrays, reducing the area overhead or allowing for a higher lane count for a given area budget.

Several experiments have been carried out to measure performance. Performance and experiments are disclosed below.

The two 32 KiB NMC macros as disclosed above were integrated inside X-HEEP (S. Machetti, P. D. Schiavone, T. C. Müller, M. Peón-Quirós, and D. Atienza, “X-HEEP: An open-source, configurable and extendible RISC-V microcontroller for the exploration of ultra-low-power edge accelerators,” 2024), an open-source, configurable and low-power RISC-V MCU. Two of the eight 32 KiB SRAM banks connected to the X-HEEP bus were replaced by NM-Caesar and NM-Carus, and the necessary configuration registers were added to the peripheral subsystem of X-HEEP. NM-Carus interrupt pin was routed to the system CPU, the OpenHW Group CV32E40P in-order 4-stages RISC-V processor implementing the RV32IMC extensions. The necessary input data is directly embedded in the firmware and loaded into the NMC macros at startup to emulate a real-world online data acquisition and processing scenario. Using worst-case timing constraints, the system was synthesized, placed, and routed on a low-power 65 nm technology library. All energy data presented in this section was collected from power analysis performed in Synopsys Primepower® 2019.12 under typical operating conditions using Value Change Dumps from system-level post-layout simulations when running selected benchmark applications.

### Benchmarks

To assess the system-level execution time and energy efficiency gains unlocked by the proposed NMC architectures, a set of representative computing kernels was selected and implemented in both a CPU-only version used as a baseline and two NMC-enhanced variants for NM-Caesar and NM-Carus. The chosen kernels, listed in Tables V and 11, constitute the basic building block for more complex applications that modern edge devices are expected to run, ranging from simple bitwise or element-wise arithmetic-logic operations to linear-algebra (matrix multiplication, 2D convolution) and machine-learning specific kernels (ReLU, max pooling). NM-Caesar instruction sequences are generated using a dedicated in-house domain-specific compiler and streamed from the memory to the NMC macro by the system DMA controller. NM-Carus kernels are written in C or RISC-V assembly, compiled using an extended version of the GNU RISC-V GCC compiler with assembler support for the xvnmc vector extension, and copied from memory to the eMEM at run time. Finally, the CPU-only kernels are compiled for the low-power system CPU using the RISC-V RV32IMC instruction set.

To ensure consistency when comparing the cycle count, all the code is compiled with the —O3 optimization flag, using the same GNU RISC-V GCC compiler, version 11.1.0.

### EXPERIMENTAL RESULTS

1) Recurrent kernels: TABLE V reports the relative execution time and energy reduction of the NMC-enhanced benchmark kernels compared to their reference CPU-only implementation.

The speedup in arithmetic and linear algebra kernels ranges from 3.3× to 28.0× for NM-Caesar and from 6.6× to 53.9× for NM-Carus, depending on the data width.

Simpler operations, such as bitwise XOR and element-wise addition, show no significant improvement when switching to lower-precision 16- and 8-bit data types. This is because the compiler's auto-vectorization optimizes the CPU code by packing multiple data items into a single GPR, resulting in a linear performance increase as data width decreases-similar to what occurs in the NMC devices. The execution time is further reduced up to 99.6 in the case of Rectified Linear Unit (ReLU) in NM-Carus, thanks to the inclusion of minimum and maximum selection instructions in its xvnmc ISA, which brings a significant speedup compared to the CPU implementation relying on inefficient data-dependent branches instead. On the other hand, the NMC architectures only achieve marginal improvement in the execution time in the max pooling kernel. The lack of sub-word reduction operations in NM-Caesar and vector reduction operations in NM-Carus requires horizontal pooling to be implemented in software in the system CPU and on NM-Carus eCPU. In general, the energy efficiency of the proposed NMC ICs follows the same trend as the throughput, with significant gains over the CPU baseline, as better visualized in FIG. 11. It must be noted that the performance gain when moving to sub-word data sizes is uniquely due to the packed-SIM D architecture of the arithmetic units inside the NMC macros. The same approach has been proven effective in conventional computing systems as well, typically in the form of dedicated ISA extensions like in already cited M. Gautschi, P. D. Schiavone, A. Traber, I. Loi, A. Pullini, D. Rossi, E. Flamand, F. K. Gürkaynak, and L. Benini, “Near-threshold RISC-V core with DSP extensions for scalable iot endpoint devices,” IEEE Transactions on Very Large Scale Integration (VLSI) Systems, vol. 25, no. 10, pp. 2700-2713, 2017).

The data in TABLE V was collected during kernel runs over large input datasets to show the maximum potential of the proposed architectures.

FIG. 12 (a and b) represents the throughput (FIG. 12 (a)) and energy (FIG. 12 (b)) scaling of NM-Caesar and NM-Carus compared to the CPU-only MCU version on several matrix multiplication kernels with different shape and bitwidth. The CPU throughput does not vary significantly with data size when using the standard RV32IMC ISA, therefore only 32-bit data is shown. Post-layout simulation data are represented; driver overhead not considered.

The results in Table V offer another important insight: the energy reduction of the NMC-enhanced kernels is lower than their throughput gain. In other words, the system draws more power when executing the same workload on the NMC macros compared to the CPU baseline. To better analyze power contributions in the system, a breakdown of the average power consumption during the execution of 8-bit and 32-bit 2D convolution kernels is shown in FIG. 13. This figure is particular represents the average power breakdown in CPU, NM-Caesar, and NM-Carus for 8-bit and 32-bit 2D convolution (post-layout simulation data). The first observation is that memory accesses represent one of the largest contributions to system power consumption in all cases, supporting CIM as a viable solution to make edge computing more energy efficient. In the CPU case, memory accesses consume approximately as much power as the CPU itself. The NM-Caesar case shows a similar overall power consumption, where memory accesses account for almost 70% of the total power, half of which is used to fetch the kernel micro-instructions and destination addresses from the system memory. Despite this, it has previously shown that NM-Caesar can process significantly more data than the CPU with the same power. The CPU disadvantage is primarily due to the explicit instructions required to move the input data between the system memory and the CPU GPRs, which are not necessary in the NMC architectures. In addition, the NM-Caesar power breakdown highlights the potential benefits of a dedicated controller that generates instructions on-the-fly instead of reading them from the system memory. This would allow NM-Caesar to achieve the same level of autonomy as NM-Carus and possibly a similar energy efficiency at the cost of reduced flexibility. Finally, NM-Carus case confirms the advantages of exploiting a vector-capable architecture that makes the power contribution of its CPU-based controller negligible compared the accesses to its four VRF SRAM banks (twice as NM-Caesar's), which account for 60% of the total system power, and significantly more than its computing resources, that consume less power than the system CPU despite producing far more output samples in the same amount of time.

2) Anomaly detection end-to-end application: To better assess the performance of NM-Caesar and NM-Carus on a representative workload, the full Anomaly Detection TinyML algorithm (Unknown, “Anomaly detection,” online, 2020, accessed:today.[Online]. Available: https://github.com/mlcommons/tiny/tree/master/benchmark/training/anomaly_detection) is deployed on the HEEPerator testbench system (FIG. 10) and compared against a multi-core CPU cluster featuring the CV32E40P RISC-V core (M. Gautschi, P. D. Schiavone, A. Traber, I. Loi, A. Pullini, D. Rossi, E. Flamand, F. K. Gürkaynak, and L. Benini, “Near-threshold RISC-V core with DSP extensions for scalable iot endpoint devices,” IEEE Transactions on Very Large Scale Integration (VLSI) Systems, vol. 25, no. 10, pp. 2700-2713, 2017) with its DSP-enhanced RV32IMCXcv ISA. The application implements an autoencoder composed of ten matrix-vector multiplication layers with ReLU activation functions.

TABLE VI reports the cycle count, energy consumption, and area of a minimal system configured with a single-, dual-, and quad-core CV32E40P, as well as a tiny RISC-V CV32E20 core (referred to as micro-riscy in P. Davide Schiavone, F. Conti, D. Rossi, M. Gautschi, A. Pullini, E. Flamand, and L. Benini, “Slow and steady wins the race? a comparison of ultra-low-power risc-v cores for internet-of-things applications,” pp. 1-8,2017) coupled with either NM-Caesar or NM-Carus. The CPU-based configurations include a single 32 KiB SRAM bank as the L1 data cache, which is replaced with the NMC devices in the respective configurations. To ensure a fair comparison, the multi-core CPU configurations are evaluated under the assumption of ideal linear scaling in both performance and area. Additionally, to focus the comparison on the computational capabilities of the systems, the contribution of the instruction memory is excluded from the energy consumption analysis.

As highlighted in the table, NM-Caesar achieves a 30% higher throughput and 20% lower energy consumption compared to the single-core system, while also occupying 10% less area. However, it is slower and less energy-efficient than the multi-core configurations, making it an ideal candidate for area-constrained devices. On the other hand, NM-Carus performs within 13% of the quad-core system while consuming half the energy and requiring less area than the dual-core configuration. This is a significant result, as it demonstrates the scalability potential of a multi-instance NM-Carus-based data memory subsystem for energy-constrained applications.

Comparison with the State of the Art

To better position the disclosed NM-Caesar and NM-Carus NMC architectures in the context of state-of-the-art CIM solutions, the memories performance have been compared against representative IMC and NMC ICs: (1) BLADE (from: W. A. Simon, Y. M. Qureshi, M. Rios, A. Levisse, M. Zapater, and D. Atienza, “BLADE: An in-cache computing architecture for edge devices,” IEEE Transactions on Computers, vol. 69, no. 9, pp. 1349-1363, 2020), an in-SRAM computing architecture that utilizes local wordline groups to perform energy-efficient computations, (2) Computational SRAM (C-SRAM) (from: M. Kooli, A. Heraud, H.-P. Charles, B. Giraud, R. Gauchi, M. Ezzadeen, K. Mambu, V. Egloff, and J.-P. Noel, “Towards a truly integrated vector processing unit for memory-bound applications based on a cost-competitive computational SRAM design solution,” J. Emerg. Technol. Comput. Syst., vol. 18, no. 2, April 2022), a hybrid IMC and NMC scalable integrated vector unit, and (3) Vecim (from: Y. Wang, M. Yang, C.-P. Lo, and J. P. Kulkarni, “30.6 Vecim: A 289.13GOPS/W RISC-V vector co-processor with compute-in-memory vector register file for efficient high-performance computing,” in 2024 IEEE International Solid-State Circuits Conference (ISSCC), vol. 67, 2024, pp. 492-494), a high-performance vector coprocessor based on [M. Cavalcante, F. Schuiki, F. Zaruba, M. Schaffner, and L. Benini, “Ara: A 1-GHz+ scalable and energy-efficient RISC-V vector processor with multiprecision floating-point support in 22-nm FD-SOI,” IEEE Transactions on Very Large Scale Integration (VLSI) Systems, vol. 28, no. 2, pp. 530-543, 2020] that exploits IMC to offer top-in-class energy efficiency.

TABLE VII provides a quantitative and qualitative overview of the features, architecture, physical characteristics, and performance of these designs compared to NM-Caesar and NM-Carus despite their technology, size and architecture differences. To establish a fair comparison from a technological standpoint among the different works, BLADE's and C-SRAM's physical characteristics were normalized by applying approximate scaling factors based on the scaling of an SRAM bitcell from their original technologies to the target 65 nm CMOS technology at the basis on NM-Caesar, NM-Carus, and Vecim. Since both designs are memory-dominated, the scaling factors were applied to both the memory and logic area, thus resulting in optimistic 65 nm values for BLADE and C-SRAM. The energy scaling factors have been defined as the ratio between the energy cost of a read operation from a 6T or 8T SRAM of equivalent array size implemented in a 65 nm technology and the original 28 nm (BLADE) or 22 nm (C-SRAM) nodes.

Among the considered architectures, NM-Carus achieves the highest peak energy efficiency, that is 6% higher than Vecim and 21% higher than the multi-array BLADE implementation. NM-Caesar excels in memory density while maintaining high energy efficiency, especially if coupled with a dedicated controller mentioned previously. The Vecim vector coprocessor delivers the best peak performance thanks to its highly parallel execution units while offering a throughput per area within 15% to the multi-array BLADE instance. A similar performance density is expected from NM-Carus instances with a higher lane count, since its throughput scales almost linearly with the number of ALUs, while the area overhead of the additional logic and the smaller VRF banks is contained.

To better compare the performance of the considered CIM architectures, TABLE VIII reports the peak throughput and the energy consumption of BLADE, C-SRAM, NM-Caesar, and NM-Carus when executing a matrix multiplication on different data widths. The throughput of BLADE and C-SRAM was estimated based on the values reported in the respective articles for multiplication operations. Because they have been implemented as 2 KiB and 4 KiB macros, 16 and 8 instances have been considered, respectively, to match the 32 KiB memory capacity of NM-Caesar and NM-Carus. A single 32 KiB instance of BLADE is also included to show its scaling versus capacity. Structural hazards and data replication for data sizes exceeding the array's dimension are not considered for BLADE and C-SRAM. Similarly, it has been considered only the proportional increase in static leakage power for a 32 KiB BLADE subarray when evaluating its energy consumption, not taking into account the increase in dynamic power. All these choices were made not to penalize or underestimate the performance of BLADE and C-SRAM, placing them under optimal conditions in an attempt to provide a fair comparison with the NMC architectures as disclosed. NM-Carus achieves 1.31× and 1.97× faster execution time than the multi-array BLADE implementation on 16-bit and 8-bit data respectively, performing 2.1× worse only in the 8-bit kernel because of the better scaling of BLADE's add-and-shift multiplier architecture for smaller data types. However, BLADE's performance may be degraded in real-world scenarios because of unsupported inter-bank operations. NM-Carus is also the most energy-efficient design, consuming up to 3× less energy than BLADE on 32-bit data. NM-Caesar, on the other hand, achieves the same 32-bit performance of BLADE at 60% its power consumption and half its area. The single-array BLADE instance and the multi-array C-SRAM perform worse than NM-Carus or the multi-array BLADE in all cases. In this regard, it must be noted that the C-SRAM data has been extracted from silicon measurements instead of post-layout simulations, possibly explaining the discrepancy. With the increasing deployment of computationally intensive algorithms on low-power devices, reduced-precision models utilizing sub-byte data types are becoming increasingly popular. CIM architectures that employ serial multipliers, such as the add-and-shift units in BLADE and C-SRAM, would achieve higher energy efficiency than the proposed NMC devices when dealing with such models. However, the ALU of NM-Caesar and NM-Carus were specifically designed for standard data types, which gives no advantage when handling lower-precision models, as their data would be sign-extended to 8 bits.

In conclusion, the following aspects and advantages of the disclosure as herein summarized. The disclosure concerns NM-Caesar and NM-Carus, two novel architectural variations of a new N MC approach that targets energy-efficient and low-power SoC designs for edge computing devices running TinyML algorithms on the edge. Leveraging the NMC paradigm, they enable the execution of arithmetic operations next to the memory array without the need to transfer data through the system bus. By performing computation on vectors in a SIM D manner, they can improve the throughput and energy performance of conventional architecture relying on energy-efficient CPUs or state-of-the-art IMC/NMC architectures. Experimental results have shown that NM-Caesar and NM-Carus achieve a timing speed-up of up to 25.8× and 50.0×, as well as a reduction in energy of 23.2× and 33.1× compared to a scalar architecture based on RISC-V in a matrix multiplication kernel. In particular, a 65 nm implementation of NM-Carus demonstrates a peak energy efficiency of 306.7 GOPS/W with 8-bit data. In addition, their software-friendly digital-based design approach will ease their integration into existing systems without any major changes for optimal performance across different technology nodes.

Advantageously, according to the system and memories of the present invention, an integration model is provided where compute-capable drop-in replacements for conventional SRAMs can be arbitrarily programmed to process data in place, with minimal impact on the host's software stack and physical characteristics. NM-Caesar achieves a higher bitcell density and energy efficiency thanks to smaller single-port memories at the cost of no support for vector operations and lower throughput. The innovative paradigm as disclosed differentiates from the existing CIM solutions due to the transparent integration of the memory compute elements inside the memory subsystem of the host SoC. The proposed NMC architectural variants offer a very low-impact integration effort from a software and hardware standpoint, combining the inherent advantages of SRAM-based CIM with the flexibility and portability of programmable accelerators

The system according to the present disclosure, with the aim to support a widespread adoption of data-centric algorithms, particularly Artificial Intelligence (AI) and Machine Learning (ML), overcomes the limitations of centralized processing infrastructures and drives a shift towards edge computing. Stringent constraints on energy efficiency, which traditional cannot be support by von Neumann architectures, are met. Although the Compute-In-Memory (CIM) paradigm has emerged as a candidate to address the problem above, due to its efficient exploitation of available memory bandwidth, it requires high implementation effort and lacks flexibility from a software integration standpoint. Instead, the system according to the present disclosure is software-friendly, general-purpose, and involves a low-integration-effort Near-Memory Computing (NMC) approach, and paves the way for the adoption of a new CIM-based system in the next generation of edge computing nodes. The two architectural variants, NM-Caesar and NM-Carus, are proposed and characterized to better target different trade-offs in area efficiency, performance, and flexibility, covering a wide range of embedded microcontrollers. Post-layout simulations has shown up to 25.8× and 50.0× lower execution time and 23.2× and 33.1× higher energy efficiency at the system level, respectively, compared to executing the same tasks on a state-of-the-art RISC-V CPU (RV32IMC). NM-Carus achieves a peak energy efficiency of 306.7 GOPS/W in 8-bit matrix multiplications, surpassing recent state-of-the-art in- and near-memory circuits.

Acronyms as used in the present disclosure are as follows:

| | | |
|---|---|---|
| AI: Artificial Intelligence | | |
| ALU: Arithmetic Logic Unit | | |
| ANN: Artificial Neural Network | FPGA: Field-Programmable Gate | PVT: Process, Voltage, and |
| | Array | Temperature |
| API: Application Programming | FSM: Finite State Machine | ReLU: Rectified Linear Unit |
| Interface | | |
| ASIC: Application-Specific | GCC: GNU Compiler Collection | RISC: Reduced Instruction Set |
| Integrated Circuit | | Computer |
| CGRA: Coarse-Grained | GEMM: General Matrix | ROM: Read-Only Memory |
| Reconfigurable Architecture | Multiplication | |
| CIM: Compute-In-Memory | GPR: General-Purpose Register | RRAM: Resistive Random Access |
| | | Memory |
| CNN: Convolutional Neural | HDL: Hardware Description | RTL: Register Transfer Level |
| Network | Language | |
| CPU: Central Processing Unit | IC: Integrated Circuit | RVV: RISC-V Vector Extension |
| CSR: Control and Status Register | IMC: In-Memory Computing | SEW: Selected Element Width |
| DMA: Direct Memory Access | IoT: Internet of Things | SIMD: Single Instruction Multiple |
| | | Data |
| DNN: Deep Neural Network | ISA: Instruction Set Architecture | SoC: System-on-Chip |
| DRAM: Dynamic Random Access | MAC: Multiply-and-Accumulate | SRAM: Static Random-Access |
| Memory | | Memory |
| DSP: Digital Signal Processor | MCU: Microcontroller Unit | VCD: Value Change Dump |
| eCPU: embedded CPU | ML: Machine Learning | VPU: Vector Processing Unit |
| eMEM: embedded Memory | MRAM: Magnetoresistive | VRF: Vector Register File |
| | Random Access Memory | |
| ENMV: Embedded Non-Volatile | NMC: Near-Memory Computing | X-HEEP: eXtendable |
| Memory | | Heterogeneous Energy-efficient |
| | | Platform |
| FFT: Fast Fourier Transform | PCM: Phase-Change Memory | |
| FLL: Frequency-Locked Loop | PE: Processing Element | |

1. A system including
a host system comprising configuration registers and a system bus including at least one data bus to read and write data from at least one memory;
at least one memory removably connectable to the data bus to form at least part of the memory space of the host system, the at least one memory including a pin routed to one of said configuration registers when the at least one memory is connected to the host system;
the at least one memory being configurable by the host system in one amongst a transparent memory mode for reading and writing from/into the at least one memory and a computing mode for programming elaboration kernels into the at least one memory;
wherein said host system is configured to switch the at least one memory between transparent memory mode and computing mode by setting said one of the configuration registers in the host system and
wherein the host system, with the at least one memory switched on the computing mode, is configured to program the elaboration kernels by transmission of instructions via the data bus and to read results directly therefrom, without loading and storing instructions.

2. The system according to claim 1, wherein the at least one memory includes
at least one arithmetic logic unit;
a controller comprising a decoder connected to said routed pin, and an arithmetic logic unit scheduler, the decoder being configured for interfacing with the data bus of the host system, and the arithmetic logic unit scheduler being configured to schedule arithmetic operations;
a data memory, wherein said data memory includes at least two single-port SRAM banks, and said at least one arithmetic logic unit is connected to the data memory by means of a multiplexer connected to the two single-port SRAM banks and to the arithmetic logic unit.

3. The system according to claim 1, wherein said instructions includes logic operations, integer and optionally fixed- and floating-point multiplication, MAC, dot product, minimum and maximum selection, and shift operations.

4. The system according to claim 1, wherein, in said computing mode, the decoder is configured to interpret write transactions on said data bus as the instructions, wherein an opcode of the instructions is encoded in the six most significant bits of the data bus, the opcode is followed by a word address of two source operands, relative to at least one memory base address.

5. The system according to claim 1, wherein the at least one memory includes
a controller including a CPU with 16 General-Purpose Registers, an embedded memory for code and data, and a configuration register interconnected through a single-channel bus, the single-channel bus being connectable to said data bus of the host system by means of a multiplexer also connectable to said one configuration register of the host system by means of said routed pin;
a vector processing unit including a decode stage connected to the controller by means of a dedicated instruction offloading interface, an execution stage to execute the instructions and a shared common unit handing synchronization with the CPU,
a data memory, the data memory forming a vector register file including a configurable plurality of single-port SRAM banks.

6. The system according to claim 5 wherein, in computing mode, the host system is configured to program the embedded memory with a kernel code by accessing the configuration register of said controller.

7. The system according to claim 6 wherein, the at least one memory is configured to be set back from the computing mode to the normal memory mode during the kernel execution, and wherein, to signal the end of the computation to the host system once the kernel terminates, a dedicated status bit is set in the at least one memory or a dedicated optional pin (irq) of the at least one memory is set as an interrupt source.

8. The system according to claim 5, wherein the execution stage includes a plurality of arithmetic logic units, a permutation unit and a CRS unit, and wherein each one of the single-port SRAM banks is connected to a corresponding one of the arithmetic logic units by means of a second multiplexer, the second multiplexer being connected to said multiplexer via a bus.

9. The system according to claim 5, wherein the configuration register of the controller is configured to implement synchronization with the host system.

10. The system according to claim 5, wherein the CPU is a RISC-V CPU implementing the RV32EC instruction set architecture.

11. The system according to claim 5, wherein the CPU is configured to offload instructions to the vector processing unit via a dedicated instruction offloading interface.

12. The system according to claim 11, wherein the offloaded instructions are vector instructions from a custom xvnmc instruction set architecture extension, said custom xvnmc instruction set architecture extension implementing at least the following operations: integer single-width arithmetic, logic, shift operations, vector permutation instructions comparable, and further implementing exchange of data between an element of a vector register and the General-Purpose Registers.

13. The system according to claim 12, wherein said exchange of data allows a CPU code to interact with a content of the vector register file, the vector register file being not accessible by any load and store instructions.

14. The system according to claim 12, wherein the custom xvnmc instruction set architecture extension includes instruction variants supporting indirect register addressing, wherein the variants encode index of source and destination vector registers in the three least-significant bytes of a scalar general-purpose register.

15. The system according to claim 12, wherein a same vector instruction is reusable in every loop iteration with different operands by updating the scalar General-Purpose Register.

16. A memory removably connectable to the data bus of a host system to form at least part of the memory space of the host system,
the memory including a pin suitable to be routed to a configuration register of the host system, when the memory is connected to the host system;
the memory being configurable in one amongst a transparent memory mode for reading and writing data in the memory and a computing mode for programming elaboration kernels into the memory based on a setting of said pin driven by the configuration register, and wherein
in use, when the memory is switched on the computing mode, the memory program the elaboration kernels by means of instructions received via the data bus without any load or store instruction and allows read results of elaborations directly from the data bus.

17. The memory according to claim 16, including
a controller comprising a decoder connected to said routed pin, and an arithmetic logic unit scheduler, the decoder being configured for interfacing with the data bus of the host system, and the arithmetic logic unit scheduler being configured to schedule arithmetic operations;
a data memory including a two single-port SRAM banks, wherein said arithmetic logic unit is connected to the data memory by means of a multiplexer connected to the two single-port SRAM banks and to the arithmetic logic unit.

18. The memory according to claim 16, including
a controller including a CPU, an embedded memory, and a configuration register interconnected through a single-channel bus, the single-channel bus being connectable to said data bus of the host system by means of a multiplexer also connectable to said one configuration register of the host system by means of said routed pin;
a vector processing unit including a decode stage connected to the controller by means of a dedicated instruction offloading interface, an execution stage to execute the instructions and a shared common unit handing synchronization with the CPU,
a data memory, the data memory forming a vector register file including a configurable plurality of single-port SRAM banks.
